(19) United States
(12) Patent Application Publication
(10) Pub. No.: US 2008/0197054 A1
(43) Pub. Date: Aug. 21, 2008

(54) Means and Method for Classifying Logs

(75) Inventor: Hakan Lindstrom, Uppsala (SE)

Correspondence Address: YOUNG & THOMPSON, 209 Madison Street, Suite 500, ALEXANDRIA, VA, 22314, US

(73) Assignee: A-SORT AB, UPPSALA (SE)

(21) Appl. No.: 11/995,738

(22) PCT Filed: May 31, 2006
(86) PCT No.: PCT/SE2006/050177

§ 371 Date: May 1, 2008

(30) Foreign Application Priority Data
Jul. 15, 2005 (SE) 0501709-0

(51) Int. Cl. B07C 5/14

(52) U.S. Cl. 209/517

(57) ABSTRACT

A mechanism (1000) for classifying logs based on a combination of transit time technology and resonance-based technology is provided. Pressure impulses are applied to a log (4) so as to produce acoustic waves in the log. Acoustic measurements are performed using transit time technology and resonance-based technology, respectively, to obtain a maximum and an average impulse velocity, respectively, of the log. The log quality is evaluated based on the different impulse velocities, forming a radial impulse velocity gradient of the log. The quality algorithm can include a combination of MOE and radial wood gradients to improve the accuracy further. Other parameters, such as log shape, weight, temperature, may also be included. The system can utilize impulses separated in space and time, where differences in impulse velocities between transmitter-receiver paths reflect internal wood defects. The log is classified (and sorted) using criteria or thresholds dependent on the log quality.

### TECHNICAL FIELD

The present invention generally relates to handling of saw logs, and in particular to a method and means for classification of logs based on their material properties.

### BACKGROUND

Industries based on biological material, such as the sawmill industry, are characterized by using raw material with a large natural variation, which leads to a large variation in the product quality. Therefore, for the sawmill industry, standards defining requirements on construction lumber with regard to form stability, drying distortion, elasticity, strength, etc have been defined (e.g. in Swedish and International standards). In parallel, there are also grading standards for visual appearance quality of sawn lumber in terms of allowance and size of knots, rot, cracks, resin, discoloration, or other visual defects (e.g. in Swedish and International standards). In view of this, there is a general need in the sawmill industry for appropriate procedures for determining wood properties in order to grade or classify wood products. In particular, it would be desirable to be able to presort logs in objective property classes to allow better utilization.

Acoustic measurements on wood have been performed for more than twenty years but not until recently the interest for such methods has grown. There are now a number of suppliers of hand-held tools for direct measurement of wood properties through acoustic speed parameters. Such tools include twin-probe tools for measurements on standing trees using transit time technology, see New Zealand Patent NZ 533153 for example, as well as tools for resonance-based measurements on impulses created by means of a hammer. A tool of the latter kind is disclosed in NZ 333434, which is directed towards acoustic measurements for determining suitable cut positions for logs.

In the Swedish patent SE 511 602, a method and device for nondestructive determination of properties of elongated or board formed objects. An acoustic wave is produced by impact excitation and resonance frequencies of the object are registered. Stiffness, strength and/or structural properties of the object are determined, and based on this classification and sorting can be achieved. The objects are preferably sawed wood, and the method is not described for any application to classification of raw timber prior to sawing.

In the British patent GB 1 244 699, a non-destructive method of grading wood materials is disclosed. The propagation time of an acoustical wave through the wood is measured, a velocity of propagation is derived, and properties of the wood material are determined therefrom.

Although the conventional procedures for acoustic speed measurements on wood have resulted in possibilities of an improved wood handling in the field, they are in general not sufficiently well suited for sorting logs in sawmill processes. The measurement parameters proposed in prior art are not matching the most important quality properties of unsawed logs very well. The methods are associated with low accuracy and unreliable results and there is a need for a more sophisticated mechanism for classifying logs.

### SUMMARY

A general object of the present invention is to provide an improved procedure for classifying logs. A specific object is to achieve log classification based on acoustic technology with an increased accuracy and reliability. Another object is to enable automated pre-sorting of logs in quality classes. Still another object is to provide log classification suitable for use in mobile sorting systems.

These objects are achieved in accordance with the attached claims.

The present invention is based on the recognition that new information regarding wood properties and quality can be obtained through acoustic measurements performed such that transit time technology is combined with resonance technology by means of a difference measure. These two technologies are based on entirely different principles, and by themselves provide results of a comparatively low accuracy that are associated with a high standard deviation. By combining them in a difference measure proposed by the present invention, on the other hand, new information, such as velocity gradients, is obtained, which are more directly related to important properties of the timber. The use of a difference measure leads to a considerable improvement in the determining of drying properties, such as form stability and/or drying distortion/deformations, of the wood in individual logs.

A procedure for sorting logs based on transit time technology and resonance-based technology is thus provided. Pressure impulses are applied to a log so as to produce acoustic waves in the log. Acoustic measurements are performed using transit time technology as well as resonance-based technology. Hereby, a first impulse velocity and a second impulse velocity of the log are obtained, typically produced so as to represent a local maximum impulse velocity and an average impulse velocity, respectively. The log quality is thereafter evaluated based on a difference between the first and second impulse velocities, preferably expressed as a radial impulse velocity gradient of the log. By determining the drying properties of logs based on radial impulse velocity gradients, the accuracy of the log classification can be considerably improved as compared to when using previously known methods. The algorithm(s) used for quality evaluation preferably also includes the modulus of elasticity (MOE). Other parameters that have been found to greatly influence the accuracy of the results, such as log shape, weight and/or temperature, may optionally be included in the quality evaluation.

The log is classified according to the determined log quality, i.e. using criteria or thresholds dependent on the log quality. The obtained data can for example be fed into algorithms that control the pre-sorting of saw logs into a number of predefined objective log quality classes by means of an automated system. A preferred embodiment of the invention provides a procedure for pre-sorting saw logs in objective quality classes related to form stability, modulus of elasticity, knot content and wood defects.

According to particular embodiments, the acoustic transit time measurements are performed so as to produce a number of impulses distributed radially around the log and/or separated in time. This enables statistical analyses of the wood properties and a further improved accuracy in the log evaluation and sorting. Variance and standard deviation can for example be calculated based on measured impulse velocities in a set of radial sectors of the log so as to represent the propensity for drying distortion and form stability variation of the lumber sawn from a log. Using an array of transit time transmitters and receivers coupled to the log and producing impulses separated in time allows further signal analysis that can be used to detect wood variation and presence of internal wood defects in the logs.

According to other aspects of the invention a system for classifying logs, a mobile sorting unit including such a system, and a classification unit are provided.

### BRIEF DESCRIPTION OF THE DRAWINGS

The invention, together with further objects and advantages thereof, is best understood by reference to the following description and the accompanying drawings, in which:

FIG. 1A is a perspective view of a measurement station of a system for classifying logs in accordance with an exemplary embodiment of the present invention;

FIG. 1B is a close up of a measurement unit in the measurement station of FIG. 1A;

FIG. 2A is a perspective view of a measurement station of a system for classifying logs in accordance with an exemplary embodiment of the present invention;

FIG. 2B is a close up of a measurement unit in the measurement station of FIG. 2A;

FIG. 3A illustrates means for transit time measurements, in an open condition, in accordance with an exemplary embodiment of the present invention;

FIG. 3B illustrates means for transit time measurements, in a closed condition, in accordance with an exemplary embodiment of the present invention;

FIG. 4 illustrates means for resonance measurements in accordance with an exemplary embodiment of the present invention;

FIG. 5 is a diagram illustrating simplified log sorting criteria in accordance with an exemplary embodiment of the present invention;

FIG. 6 is a schematic block diagram of a system for classifying and sorting logs according to an exemplary embodiment of the present invention;

FIG. 7 is a flow chart of a method for classifying logs according to an exemplary embodiment of the present invention; and

FIG. 8 is a diagram illustrating relations between local maximum impulse velocity, average impulse velocity and velocity gradients.

### DETAILED DESCRIPTION

Throughout the drawings, the same reference numbers are used for similar or corresponding elements.

For the purpose of this disclosure, drying distortion refers to the drying deformations or defects that are observed upon drying the sawn lumber. Form stability (also referred to as shape stability) is the ability of the wood material/wood products to resist long-term lumber shape deformation. Form stability is typically measured or observed by repeated humidification and drying events.

The present invention provides a new kind of log classification system, based on more sophisticated acoustic measurement and evaluation procedures than the rough procedures according to the prior-art. The proposed measurement scheme uses transit time technology in combination with resonance based technology in a new and advantageous manner that will be described in detail in the following. Briefly, acoustic parameters are determined and combined into a representation of the quality or drying properties of the log. Hereby, an impulse velocity gradient may be formed using different types of measures of the impulse velocity. Such a parameter represents gradients in the wood properties of individual logs, which are due to radial variations in the wood structure, for example with regard to micro fibril angle, spiral grain, variation in knot frequency/knotsize, and compression wood.

The principles of the invention will now be described further with reference to particular embodiments thereof. First, the measurements performed on the log will be described in the section “Log measurements”. Thereafter, the use of the measurements will be explained in the section “Quality evaluation” and finally log classification and sorting based on the quality evaluation are addressed in the section “Log classification and sorting”.

### Log Measurements

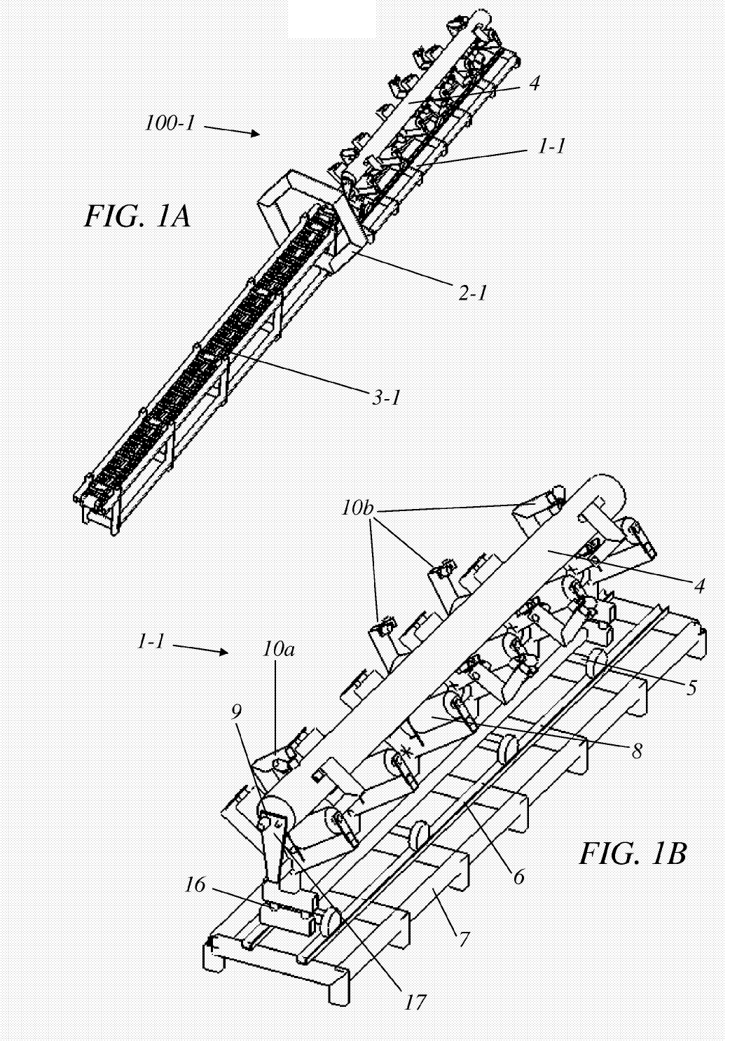

FIG. 1A illustrates an exemplary measurement station of a system for classifying logs in accordance with an embodiment of the present invention. The illustrated measurement station 100-1 uses a longitudinal set-up. The respective logs 4 are transported in a substantially lengthwise direction via a measurement unit 1-1 provided with equipment for measuring wood properties. The measurement unit 1-1 preferably moves along with the log 4 during the measurement, whereby the sensors obtain better contact with the wood. This movement should be provided for at least a portion of the time of measurement. Preferably, the sensors move with the log about 1.0 m but generally about 0.5 m will be sufficient to achieve good contact and time for measurements. After measurement, the logs 4 proceed on a longitudinal conveyor 3-1 on their way to the actual sorting.

FIG. 1B is a close up of the measurement unit 1-1 of FIG. 1A. The measurement unit 1-1 comprises a carriage 5 arranged for longitudinal (lengthwise) movement along rails 6 of a frame 7. As the log 4 enters the carriage 5, it is transported by means of feeding rollers 8, which cause movement of the log in a substantially lengthwise direction towards means 9 for resonance measurements. Means 10a, 10b for transit time measurements encloses/engages with the log 4 through a transmitter subunit 10a and a receiver subunit 10b (preferably the one of a number of receivers 10b that is positioned as far away from the transmitter 10a as possible while still being within the length of the log 4). The carriage 5 starts and during the measurement it moves with the log 4. After collection of the appropriate data, the carriage 5 returns to its original position, ready to receive another saw log 4. Hereby, the speed of the feeding rollers 8 is preferably adjusted such that the log 4 moves forward with a substantially constant speed as the carriage 5 moves backward.

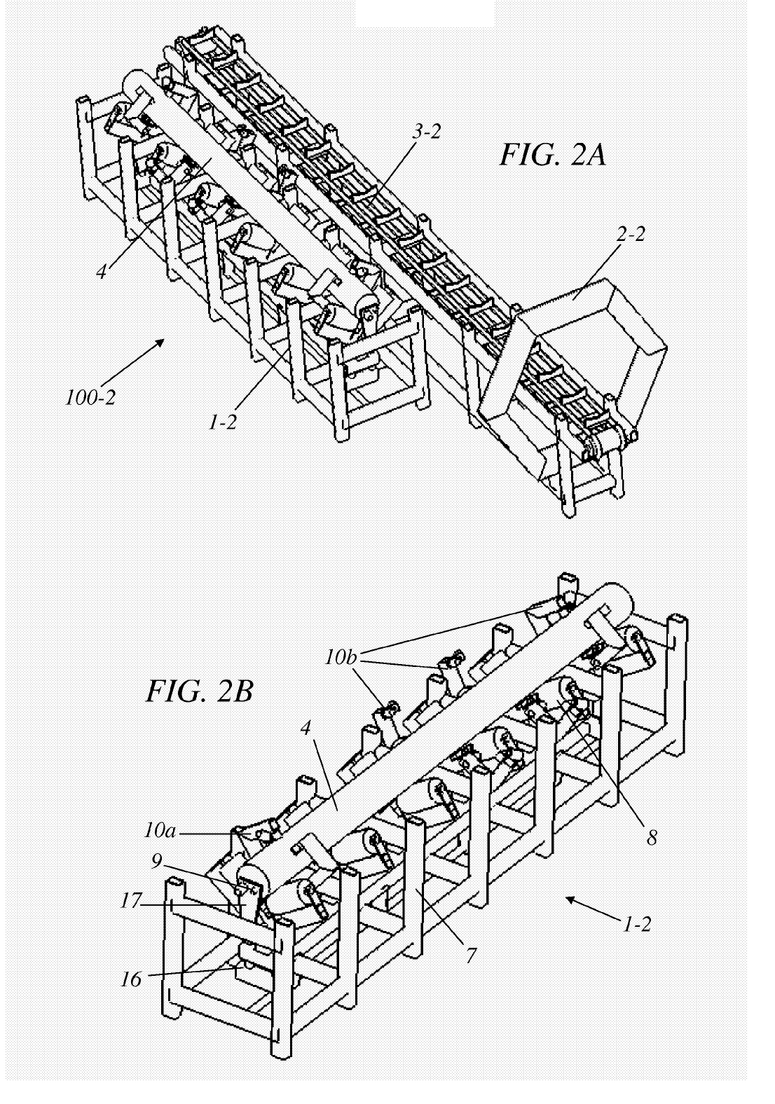

FIG. 2A shows another exemplary measurement station 100-2, in which the measurement components are instead arranged in a transverse set-up. The measurement unit 1-2 of FIG. 2A is arranged beside the conveyor 3-2, whereby the log 4 has to be moved in a transverse direction in order to get to the measurement point. The wood properties can for example be measured during the transverse movement placing the log 4 in the measurement unit 1-2.

FIG. 2B is a close up of the measurement unit 1-2 of FIG. 2A. The log 4 enters the V-shaped block of feeding rollers 8 with a transverse (sideward) movement. As before, the feeding rollers 8 cause movement of the log 4 towards means 9 for resonance measurements. Means 10a, 10b for transit time measurements encloses/engages with the log 4 through a transmitter subunit 10a and a receiver subunit (preferably the one of a number of receivers 10b that is positioned as far away from the transmitter 10a as possible while still being within the length of the log 4). The measurement of wood quality parameters is preferably performed with the sensors during transverse movement of the log 4 (and the sensors) at the measurement unit 1-2 and thereafter the log 4 is returned to the conveyor (3-2 or FIG. 2A) and the measurement unit 1-2 is ready for receiving another log 4.

### Acoustic Parameters

In order to estimate the quality and in particular drying properties such as form stability or drying distortion of a log, the present invention proposes to perform acoustic measurements on the log using transit time technology combined with resonance-based technology, for example with measurement means corresponding to sensors 9, 10a, 10b of FIGS. 1B and 2B. The transit time measurements provide an outer wood velocity of the log, which normally corresponds to a (local) maximum impulse velocity of the log. The resonance based measurements, on the other hand, are volume weighted and provide an average impulse velocity of the log. The principles of these acoustic measurements will now be briefly explained.

The acoustic measurements basically involve creating a standardized impulse, which becomes modified depending on the properties of the wood, and study the acoustic response of the impulse. The impulse can for example be produced by means of a hydraulic hammer or a compressed-air piston.

The principle of transit time technology is to measure the time t for an impulse to travel from a transmitter to a receiver. The distance x between transmitter and receiver is used to calculate the impulse velocity V₁ according to:

$${V}_{1} = \frac{x}{t} \qquad ( 1 )$$

As illustrated in FIG. 1A-2B, the equipment for the transit time measurement is normally positioned in the vicinity of the outermost portion of the log, thus producing a measure of the impulse velocity at or close to the outer radius of the log. This velocity generally corresponds to a maximum velocity, i.e. V₁=Vₘₐₓ, since it is a basic behavior of the acoustic signal to take the fastest path through the surrounding wood (with the highest modulus of elasticity). Such a maximum velocity represents the maximum velocity of a particular portion/sector of the log(normally a sector smaller than the entire cross-sectional area of the log) and will therefore also be referred to as a local maximum velocity.

It is preferred to include more than one pair of sensors (transmitter+receiver) for the transit time measurements to improve the accuracy as well as to enable statistical analyses providing additional information useful for grading the log. Preferably, n transmitters are arranged at one end of the log placed on a radial vector separated by x degrees such that each sequential pressure impulse is detected using n receivers separated with a corresponding displacement at the other end of the log. n separate impulse velocities will then be detected by the n receivers for each sequential impulse launched by the n transmitters. In a particular embodiment, the measurement points are arranged radially around the log separated by about 90 degrees, i.e. x=90. Generally, 4 measurement points, i.e. n=4, will be sufficient but additional measurement directions can also be included within the scope of the invention.

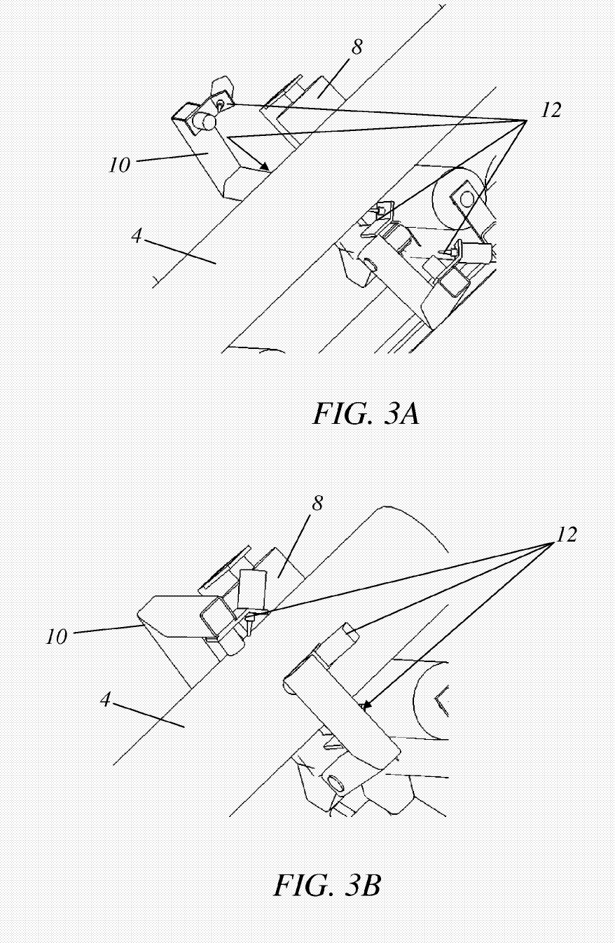

FIGS. 3A and 3B illustrate means for transit time measurements in accordance with an exemplary embodiment of the present invention. In this example, the means for transit time measurements comprises four pairs of transmitters and receivers, arranged at the respective ends of the log 4 (only one end, with a transmitter or receiver subunit 10, is shown) for measuring the maximum impulse velocity in radii a, b, c, and d of the log. FIG. 3A shows four sensors, or measurement needles 12, in an open condition, while FIG. 3B shows the needles 12 gripping into the log 4 in a closed condition during measurement. The respective measurement needles 12 of a transmitter and receiver pair 10a, 10b are normally arranged so as to face each other and be inclined with respect to the wood surface during measurement.

The location of the transmitter and receiver subunits 10a, 10b of the transit time measurement means should be in the vicinity of the log ends in order to obtain data representative of the entire log 4. In a system adapted for handling various log lengths, this can for example be achieved by adjusting the position of the transmitter subunit, the receiver subunit, or both according to the log length. Alternatively, there may, as previously explained in connection with FIGS. 1B and 2B be several transmitter or receiver subunits, in which case the system is adapted for using the subunit closest to the end of the log but within the log length for the transit time measurement.

Using an array of transit time transmitters and receivers coupled to the log and producing impulses separated in time, i.e. time-delayed with respect to each other, enables further signal analyses and statistical analyses that can be used to describe the material properties of a saw log. According to a particular embodiment, a sequential impulse is launched in the longitudinal direction of the log by a set time interval (t, t+a, t+2a, t+3a, . . . , t+na) where a is a given time interval between the respective impulses produced at n transmitters at n contact points on one end of the log.

The resonance-based technology relies on producing an impulse at one end of the log and measuring the eigenfrequency f (i.e. natural frequency) of the log. The frequencies close to this eigenfrequency and multiples thereof (2f, 3f, . . . ) will be amplified. Basically, the eigenfrequency f is associated with the time for the acoustic wave to travel from one end of the log to the other and then back again, i.e. a distance of 2l, where l is the log length. As the acoustic wave propagates through the wood, the frequency becomes representative for the entire volume of the log. The measured resonance frequency f of the log is used to calculate the impulse velocity V₂ as:

V₂=2lf (2)

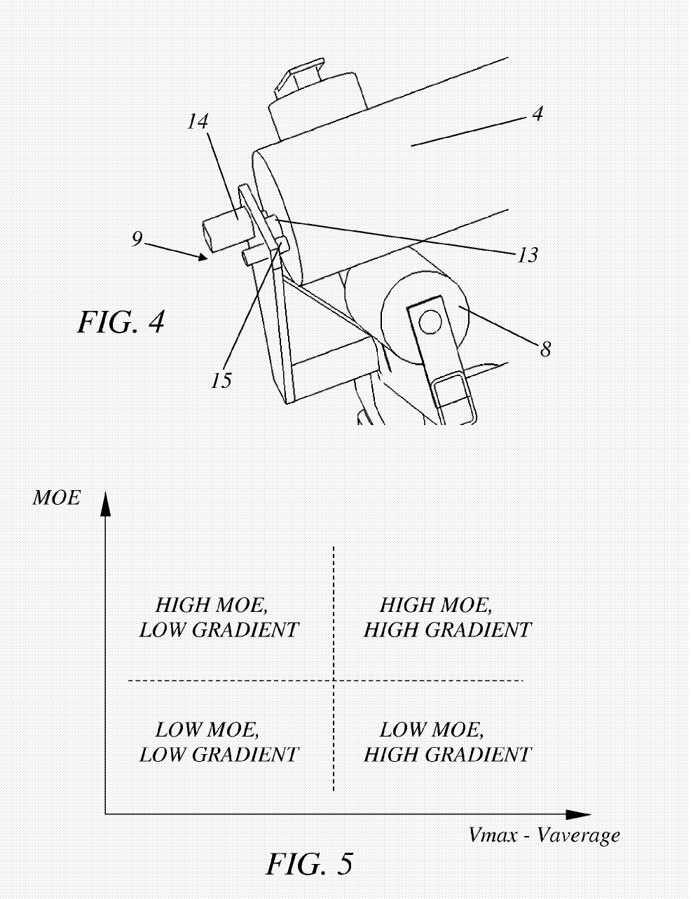

FIG. 4 illustrates means for resonance measurements in accordance with an exemplary embodiment of the present invention. A log 4 is arranged in position for acoustic measurements with one of its ends pressed against a stop member 13 of the measurement unit. The means 9 for resonance measurements comprises a hammer 14 for producing the impulse and a probe/sensor 15 for registering the resonance frequency of the impulse.

The resonance-measurements produce a measure of the average, i.e. volume-weighted, impulse velocity of the log, V₂=V_{average}.

### Geometrical Parameters

According to a particular embodiment of the invention, there is also provided means for automatically measuring the outer shape or geometry of the log in order to improve the quality evaluation and log classification further. Such means can for example comprise a laser array that gives a two or three dimensional representation of the log geometry. Important geometrical parameters include the diameter, length and taper of the log. The outer surface/shape of the log can e.g. be used for determining its knot content or for calibration of the impulse velocity measurements for obtaining a higher accuracy.

Returning to FIGS. 1A and 2A, the measurement stations 100-1, 100-2 include means 2-1, 2-2 for measuring the geometry of the log 4, e.g. by a laser scanning system. These are fixed at the frame structure of the measurement stations 100-1, 100-2 and located such that the logs 4 will pass through their opening after the acoustic measurements have been performed at the measurement unit 1-1, 1-2 but before the log 4 enters the actual (“physical”) sorting. There may also very well be embodiments where the geometry measurement precedes the acoustic measurements.

### Weight

A further improvement of a system comprising means for automatically determining geometrical log parameters can be achieved by combining such geometrical measurements with automated measurements of the weight of the individual logs. According to a particular embodiment of the present invention, a number of weight sensors are provided for measuring the weight of the individual logs in order to improve the quality evaluation and log classification further. As illustrated in FIGS. 1B and 2B, there can for example be four sensors 16 arranged such that they form corners of a rectangle over which the log 4 passes, said rectangle roughly corresponding to or being larger than the surface of the log as projected in the horizontal plane. However, anyone skilled in the art recognizes that there are alternative ways of arranging these weight sensor(s).

### Temperature

Studies performed by the inventor have shown that the impulse velocity and thus the MOE is affected by the temperature of the wood material during measurement. Therefore, according to a particular embodiment of the invention, it is suggested that the system also includes a digital thermometer enabling correction for the temperature-dependency. The digital thermometer should be arranged such that a representative value of the average temperature in the log is provided. In the examples of FIGS. 1B and 2B the measurement stations include a respective temperature sensor 17, which during measurement is positioned at one end of the log, in vicinity of the means 9 for resonance measurements.

To improve the accuracy it would of course be possible to have multiple temperature sensors but the possible improvement should then be weighted against the increased system complexity.

### Quality Evaluation

### Radial Wood Gradient

By performing transit time measurements together with resonance-based measurements as proposed in accordance with the present invention, the quality of the log can be evaluated in a new and improved manner. A quality measure can be based on both average and maximum values of the impulse velocity, as a difference thereof, thereby accounting for a radial wood gradient, expressed as an impulse velocity gradient, in the log.

A preferred embodiment of the present invention proposes to evaluate the quality of logs by means of a measure/indicator of the drying properties of the wood material (referred to as a “Drying Property Indicator”, DPI), which is defined as a function of a first impulse velocity from transit time measurements and a second impulse velocity from resonance measurements. Typically, this means that DPI=f(V_{average}, Vₘₐₓ), where V_{average} is the average impulse velocity from resonance measurements and Vₘₐₓ is the (local) maximum impulse velocity from transit time measurements. According to the present the function is based on a difference between a first impulse velocity from transit time measurements and a second impulse velocity from resonance measurements. DPI is a useful indicator of the form stability and drying distortion of a log. A DPI-value indicating a large impulse velocity gradient means that there are form stability and drying distortion problems associated with the log, or, in other words, that the log presents low form stability and high drying distortion values.

The impulse velocity gradient, for example expressed as Vₘₐₓ−V_{average}, reflects radial variations in the wood structure, such as micro fibril angle, spiral grain, density variations, and presence of compression wood. This is a useful measure of the tendency for drying deformations, since a large gradient implies that the wood will experience considerable form stability/drying distortion problems during the drying process. Examples of such problems are that the wood because of material property inhomogeneity has varying shrinkage properties in the radial, tangential, or longitudinal direction, which give rise to crook, bow, and warp in the sawn lumber. Logs with very large gradients should not be used in the saw mill and the efficiency of such an industry can be improved to a great extent if these logs are removed as early in the process as possible.

In a preferred embodiment DPI=Vₘₐₓ−V_{average} but a person skilled in the art recognizes that alternative definitions based on a difference may be used, including DPI=V_{average}−Vₘₐₓ and DPI=|V_{average}−Vₘₐₓ|. The drying property (or form stability/drying distortion) expression may also include other variable or constant terms, e.g. as in DPI=Vₘₐₓ−V_{average}+α or DPI=Vₘₐₓ−V_{average}+α+β(V_{average}), where α represents constant parameter(s) and β represents parameters dependent on the average impulse velocity. The DPI function may even include one or more non-linear terms.

Furthermore, instead of being expressed directly as an impulse velocity gradient, the radial gradient in impulse velocity may alternatively be expressed through a MOE-gradient, such as MOEₘₐₓ−MOE_{average}, or through other parameters that depend on the impulse velocity.

For the interested reader, a specific example of an algorithm for log classification with quality evaluation based on a radial impulse velocity gradient is provided in algorithm f₁ of the APPENDIX.

### Internal Velocity Variation—Radial Log Sectors

As mentioned, it is preferred to apply a number n of radially separated pressure impulses at one end of the log and perform transit time measurements at n corresponding measurement points at the other end of the log. There may for example be four impulses (and measurement points) separated by about 90 degrees. In such a case, local variations in impulse velocity can be used as a further indication of the wood drying properties of the log. The quality is evaluated based on the relationship (differences and distribution) between the n values of the first impulse velocity provided by the n transit time measurements.

The relationship between the local maximum velocities of the different sectors of the log can e.g. be expressed through the standard deviation as compared to an average taken over all measurement points. A low standard deviation implies a high form stability and thus a high wood quality, whereas a high standard deviation is an indication of wood defects. The variance between the local maximum velocities of the different sectors of the log is another useful measure of wood structure variation that can be employed in the quality evaluation according to this embodiment.

A specific example of an algorithm for log classification with quality evaluation based on the relationship between a number of radially separated transit time measurements is provided in algorithm f₂ of the APPENDIX.

### Internal Velocity Variation—Different Impulse Paths

In case the impulses are separated both in space and time, statistical analyses on the relationship between the n velocity vectors calculated from the detection of impulse arrival at each of the n receivers may be included in the quality evaluation. A number n of pressure impulses are applied such that they are time-delayed with respect to each other and the quality of the log is evaluated based also on the relationship between the n×n values of the first impulse velocity provided by n×n transit time measurements for different transmitter-receiver paths. The relationship between the velocities can for example be expressed by means of the standard deviation and/or variance.

The difference/variability between the velocities of the different transmitter-receiver paths increases with an increased material heterogeneity (i.e. wood defects) in the log, for example due to wood rot, knots, compression wood, spiral grain, etc. The level of internal impulse velocity variability, given by the n arrival times of each sequential impulse at the corresponding receivers reflects internal wood defects in the logs. Hence, the relationship between the internal velocities can provide for a further improved estimation of the quality parameters, form stability and drying distortion of the lumber that would be sawn from the log.

The variation in internal velocity gradients is derived by signal analysis and fed to the classification algorithms, whereby logs with large internal differences in impulse velocities can be detected and separated from the incoming flow of saw logs, whereas logs with low internal differences in impulse velocities may be separated and processed into high-quality products.

A specific example of an algorithm for log classification with quality evaluation based on the relationship between a number of transit time measurements separated both radially and in time is provided in algorithm f₃ of the APPENDIX.

### Quality Evaluation Based on Average MOE

Studies performed by the inventor show a close correlation between the average modulus of elasticity (MOE) of logs and the quality distribution of the sawn lumber. That is, a high log MOE implies a high MOE of the sawn lumber, indicating a high quality. Resonance based acoustic measurements, such as e.g. found in the Swedish patent SE 511 602, may therefore as suggested be used for quality classification in a certain degree. Therefore, the quality evaluation may also be based on the MOE of the log, defined as:

MOE=ρV₂² (3)

where ρ is the raw density of the log. ρ is normally assumed to be constant (1000 kg/m³ for fresh wood) but, as will be described in the following, according to a particular embodiment, it is proposed to determine ρ more accurately through an automated procedure.

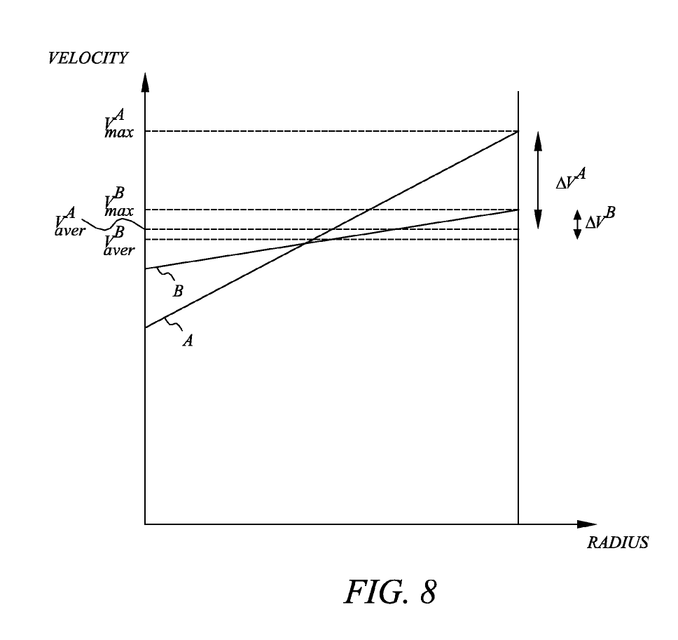

However, a quality determination based solely on an average modulus of elasticity (MOE) may be misleading, as is discussed in connection with FIG. 8. A diagram is illustrating the radial distribution of local propagation velocities in two logs A and B in a simplified view. The first log A, has a high radial velocity gradient. By measuring an average velocity in log A, a value of Vₐᵥₑᵣ^{A} is obtained. A second log B, has a low radial velocity gradient. However, an average velocity Vₐᵥₑᵣ^{B} in log B is slightly lower than for log A. According to prior art classification schemes, log A will be given a higher grade than log B. However, when considering the radial distribution, teaching from the present disclosure makes it probable that log A will present large tendency for drying deformations, while log B will present a small tendency for drying deformations. In that view, log B should be given a higher grade than log A, just opposite to what is implicated by the isolated average velocity analysis.

The situation is not better if only considering the local maximum velocity, as given e.g. from the GB 1 244 699 disclosure. In FIG. 8, a measurement of the maximum velocity of log A give a value of Vₘₐₓ^{A}. This value indicates a very high local modulus of elasticity (MOE) and would lead to a high classification. A maximum velocity of log B is given by Vₘₐₓ^{B}, which is considerably lower than for log A. Consequently, an analysis based solely on maximum velocity measurements would also give log A a higher grade than log B.

According to the present invention, an analysis should instead be primarily based on a comparison between different kinds on velocity measurements. A difference between a maximum velocity and an average velocity gives some indication of the radial velocity distribution. In FIG. 8, a difference measure for log A is defined by ΔV^{A}, and a difference measure for log B is defined by Δ^{B}. Here it can easily be seen that the difference value for log A is considerably higher than for log B, which directly points to the risk for drying deformations of log A. Log B will therefore be classified in a higher class than log A. This is opposite to the classification achieved by both of the prior classification principles. By using a combination of measurements of maximum and average velocities, information that is not available in any of the separate measurements provides an opportunity to classify logs based on completely new quantities. These quantities are more closely related to the important physical properties of the logs than quantities derivable from only one of the measurements. This is a very obvious example of a new surprising synergetic effect from two combined principles, each principle as such known in prior art.

Even if not an analysis based solely on an average modulus of elasticity (MOE) is to prefer, the information available from such an analysis can, however, be used in combination with a radial wood gradient analysis for further improving the analysis possibilities. An example of quality evaluation, based on a combination of MOE and a radial wood gradient, is illustrated in FIG. 5. It follows from the above discussion that the “best” logs are associated with a high MOE and a low gradient Vₘₐₓ−V_{average}, thus falling within the upper left quadrant.

A specific example of an algorithm for log classification with quality evaluation based on the average MOE is provided in algorithm f₄ of the APPENDIX.

### Additional Parameters for Improved Quality Evaluation

In case the system is provided with means for automatically measuring geometry (log shape), weight and/or temperature parameters, such data are preferably also included in the DPI expression to increase the accuracy of the quality evaluation and log classification further. An example of a linear expression, serving as an indicator/measure of the drying properties, is:

DPI=α+β₁·Vₘₐₓ+β₂·V_{average}+β₃·x_{geometry}+β₄·x_{weight}+β₅·xₜₑₘₚ (4)

, where α and β₁, β₂, . . . , β₅ are constants and x_{geometry}, x_{weight}, and xₜₑₘₚ are geometrical, weight and temperature parameters, respectively. The best results will in general be achieved by a function including all these parameters but there may very well be embodiments where β₃, β₄, and/or β₅=0.

A quality evaluation determined by geometry parameters in combination with acoustic parameters based on a difference between Vₘₐₓ and V_{average} (and possibly other parameters as well) results in a higher accuracy in the estimation of the velocity gradient and drying properties, and also enables an improved estimation of knot content.

When weight data is available in addition to the geometrical data, a number of advantages will be achieved. Firstly, the assumption of a constant density of 1000 kg/m³ that is used in the prior-art can be replaced by more accurate density estimations for the respective logs through an automated procedure using measurements of weight and log volume. This in turn leads to improved estimations of the velocity gradient and DPI and to improved estimations of the average MOE according to equation (3). Considerable improvements of the quality evaluation can be achieved by determining MOE and DPI based on measured weight and shape parameters, since density variations of up to 20% are not unusual. Secondly, the density determined through measured weight and shape parameters is also useful as an indication of the “freshness” of the wood. For instance, if the logs are dried out during storage before the sawing process, there may be bio-deterioration in progress, such as wood blue stain. A low density can be used as an indication of blue stain and/or similar damages. Identification of dry logs is also important since such logs may cause damages to the sawing machinery. Thirdly, a better knowledge of knot content and density in the final products will be obtained through this combination of parameters.

The quality evaluation can be further improved by means of temperature data. Temperature induced variations of the measured velocities may be as large as 20%. The quality algorithms can for example include a statistically-derived function correcting for temperature-dependencies in at least one log (wood) parameter. The temperature correction results in more accurate estimations of V₁ and V₂ and thereby in a better log classification.

The quality evaluation may for example use a DPI equation (or system of equations) implemented through a computer-executable algorithm.

Specific examples of algorithms for log classification with quality evaluation based on automatic measurements of log weight, geometry (volume), and temperature are provided in algorithms f₁, f₂, f₃, f₄ of the APPENDIX.

### Log Classification and Sorting

In accordance with the present invention logs are classified and generally also sorted based on the quality evaluation, for example using log classification algorithms that accommodate for impulse velocity (or MOE) gradients, average MOE calculated by resonance technology, log temperature, log weight and log geometry. Hereby, the above-described parameters are used as outlined above in the quality evaluation section. Classifying criteria are typically set so as to sort out logs associated with drying distortion, low form stability, and low MOE. Logs with superior drying properties and high MOE, on the other hand, may be sorted for use in production of solid wood products with high product performance.

The logs are classified/graded/sorted into at least two classes based on a combination of the parameters from the transit time and resonance measurements, respectively. An example embodiment uses three quality classes: “reject” for logs to be sorted out before sawing and which can be used as pulp or biofuel wood, “normal/ok” for logs to be processed into construction lumber, and “gold” for high-quality logs to be processed into special products. However, a person skilled in the art recognizes that other definitions and number of quality classes may be used dependent on the lumber products that the saw logs are to generate.

It should be noted that although the quality evaluation and the log classifying have mainly been described as two more or less separate events herein, these processes may very well be performed together. Acoustic and other measured parameters can for example be input to a log classifying algorithm, which involves a quality evaluation resulting in output parameters that can be used to control the actual log sorting. For more details and specific examples, reference is made to the APPENDIX.

In a particular application, the present invention is used for automated pre-sorting of logs in a sawmill before the logs enter the actual sawing process. Today, a major portion of the logs in the sawing industry are processed into construction lumber. However, it has been shown that, in Sweden, about 5% of the logs are associated with too low quality to be suitable as construction lumber or, alternatively with a very high quality meaning that they can be better used as high-quality special products. By controlling the logs in accordance with the proposed log evaluation algorithm, the present invention makes it possible to achieve better utilization of the saw logs. The logs are sorted before being processed, e.g. such that logs of average quality become construction lumber, low-quality logs become pulpwood or biofuel, whereas high-quality logs can be used as rawmaterial for high-quality products that require wood associated with low drying distortion, high form stability in use, and high load-bearing capacity. In this way, a cost-efficient sawing process is achieved.

Furthermore, the present invention can with advantage be implemented in mobile sorting units/systems. It can for example be arranged in association with machinery used in tree felling.

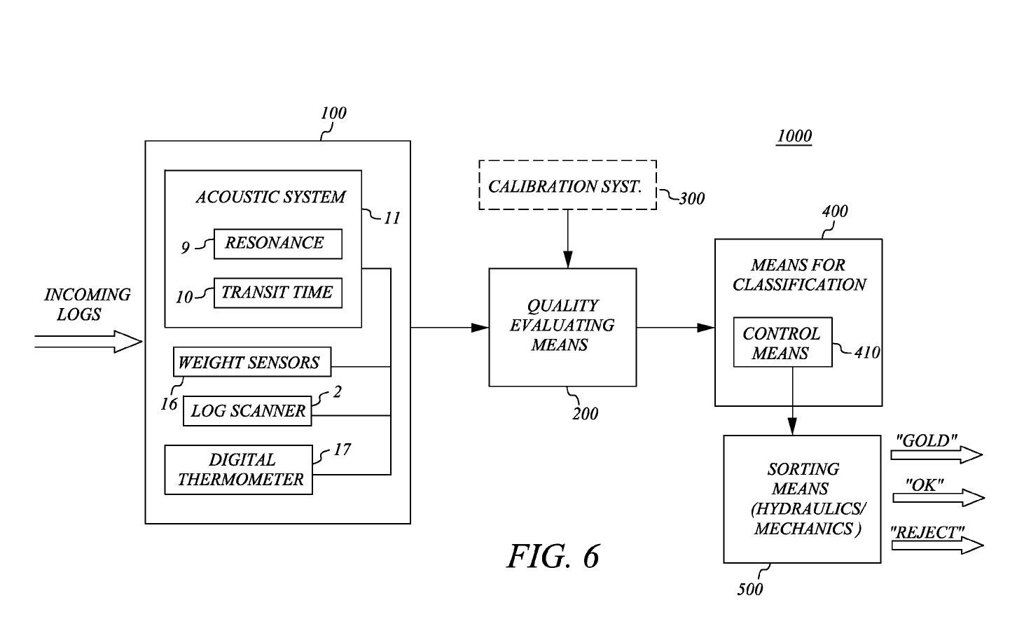

FIG. 6 is a schematic block diagram of a system 1000 for classifying and sorting logs according to an exemplary embodiment of the present invention. The system comprises a measurement unit 100 with sensors for determining acoustic and physical parameters of the log, quality evaluating means 200, an optional calibration system 300, means 400 for classifying the logs, and sorting means 500. The logs enter the system, which preferably is located before the processing of the logs (into solid wood products) in the production chain, whereby contact is achieved between the logs and the sensors 9, 10, 16, 2, 17 of the measuring unit 100. The measuring unit 100 comprises a subsystem 11 for acoustic measurements that includes sensors 9, 10 for resonance and transit time measurements, respectively, for determining impulse velocities representing at least one maximum impulse velocity, preferably a set of local maximum velocities, and an average impulse velocity. The illustrated measuring unit 100 further includes weight sensors 16, a 2D/3D laser scanner frame 2 for determining the outer shape of the log and a digital thermometer 17 for determining the wood temperature.

The data from the sensors 9, 10, 16, 2, 17 is typically transmitted over a wireless link to a computer, where it is input to an algorithm of the quality evaluating means 200. There is preferably a calibration system 300 provided for calibration of the equations/models used for evaluating (and classifying) the logs. The quality evaluating means 200 communicates with the log classification means 400 and transfers log quality parameters to a control means 410 thereof. The actual sorting can for example be performed by means of a mechanical hydraulic system 500 controlled by the control means 410 and being adapted for separating different classes of logs from each other. The system 500 sorts the logs according to the objective quality classes as determined by the control means 410. The logs of FIG. 6 are each assigned either a gold, OK (i.e. construction lumber), or reject class. However, anyone skilled in the art recognizes that there are alternative ways to achieve a flexible and continuous sorting strategy by adding threshold functions that create additional classes e.g. in order to fit the specifications of a particular sawmill.

The system 1000 of FIG. 6 thus includes means 500 for sorting the logs as determined by the control means 410. However, embodiments where the control means 410 instead communicates with external sorting means, separate from the system 1000, also lie within the scope of the invention.

According to another aspect of the present invention, the means for evaluating and classifying logs is separate from the measurement unit. A classification unit for classifying logs is provided, comprising means for receiving data/information obtained through acoustic measurements. More specifically, the receiving means is adapted for receiving a first impulse velocity parameter of a log, which is based on transit time measurements on at least one acoustic wave applied to the log, and a second impulse velocity parameter of the log, which is based on resonance measurements on at least one acoustic wave applied to the log. The classification unit further comprises means 200 for evaluating the quality of the log using the first and second impulse velocity parameters, and means 400 for classifying the log based on the quality evaluation, whereby the log can be automatically sorted accordingly. The means 200 and 400 can with advantage comprise or be implemented as a computer-executable algorithm, or a system of such algorithms.

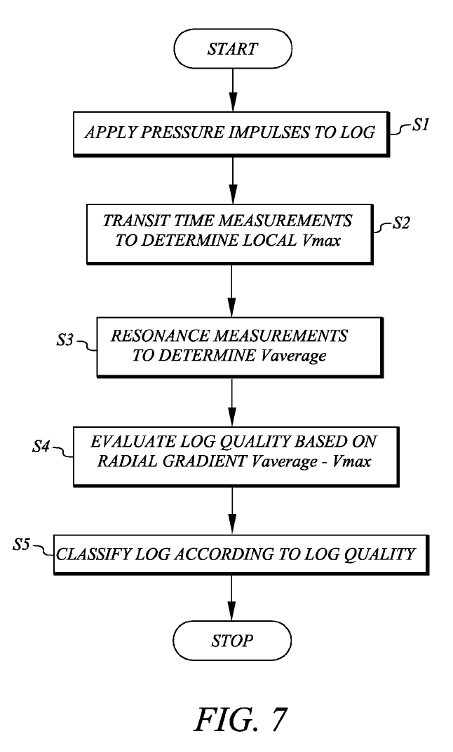

FIG. 7 is a flow chart summarizing a procedure for classifying logs according to an exemplary embodiment of the present invention. In a first step S1, pressure impulses are applied to the log so as to produce acoustic waves in the log. Acoustic measurements are performed using transit time technology and resonance-based technology, respectively (steps S2, S3). A first impulse velocity of the log is determined based on transit time measurements on at least one of the acoustic waves (step S2), and a second impulse velocity of the log is determined based on resonance measurements on at least one of the acoustic waves (step S3). The log quality is thereafter evaluated in step S4 using a difference between the first and second impulse velocities. A representation of the drying properties, such as form stability and/or drying distortion, of the log can be calculated from these velocity differences. A preferred embodiment involves calculating a radial impulse velocity gradient for the log using the first impulse velocity as a maximum impulse velocity and the second impulse velocity as an average impulse velocity.

In FIG. 7, the transit time measurement (S2) is illustrated before the resonance measurements (S3). However, in alternative embodiments, resonance measurements can be performed before or simultaneous as transit time measurements.

The quality evaluation preferably also includes other parameters, such as MOE_{average}, log shape, weight and/or temperature, which are optional. The system can also utilize impulses separated in space and time, to detect internal wood defects through differences in impulse velocities between individual transmitter-receiver paths. In a final step S5, the log is classified based on the quality evaluation, typically using criteria or thresholds dependent on log quality and/or drying properties. This log classification can with advantage be used for (automatically) sorting the log according to the classification, preferably before the log is industrially processed.

Although the invention has been described with reference to specific illustrated embodiments, it should be emphasized that it also covers equivalents to the disclosed features, as well as modifications and variants obvious to a man skilled in the art. Thus, the scope of the invention is only limited by the enclosed claims.

### APPENDIX

In this appendix, examples of algorithms for evaluating and classifying logs are provided. Hereby, the log classification relies on a system of individual classification algorithms that is used to classify incoming saw logs into log property classes according to the following general principle:

log class=funct(f₁, f₂, f₃, f₄, . . . , fₙ),

i.e. the log class output from the log classification system is determined as a function of the classification results of the n individual sorting algorithms f₁, f₂, . . . , fₙ of the system.

The classification algorithms typically relate to:
Drying distortion and form stability
Wood defects such as wood rot, compression wood, knots, spiral grain
Modulus of elasticity

Each algorithm is based on measured data, with correction functions included to compensate for variation in temperature and/or density of the logs, then a set of empirically fitted threshold values is used in each algorithm to grade/classify the logs into a number of log property classes. For simplicity, it is assumed that the threshold functions of each separate algorithm represent three log quality classes:
1=“Reject” logs—very low quality, representing maybe about 5% of all incoming logs
2=“Medium” logs—average quality, about 93% of all incoming logs
3=“Gold” logs—superior quality, about 2% of all incoming logs

A more flexible and continuous log classifying function can be achieved by adding more threshold values for each separate algorithm to allow for a sorting strategy in order to fit the specifications of an individual sawmill. The classification output parameters f₁, f₂, . . . , fₙ can also be weighted differently for different applications/sawmills.

The above algorithm system may in some embodiments be replaced by one algorithm directly accounting for all classification. In other words, the evaluation and classification may be performed in a stepwise manner or through a single algorithm execution.

Algorithm f₁

In a saw-log the highest or maximal modulus of elasticity, MOE_{MAX}, is usually found in the last formed growth rings. MOE_{MAX} can be measured with transit time technology as described with reference to FIG. 1A-3B. In the below example of Eq. (1), four transmitters and receivers are placed on a parallel radial vector at c. 0°, 90°, 180°, and 270° around the log circumference (FIGS. 3A and 3B) that, using the shortest distance between each transmitter-receiver pair, allow sampling and determination of the maximum impulse velocity in 4 separate radial sectors of the log to calculate MOE_{MAX} of the log:

$${MOE}_{MAX} = f ( t ) ρ ( \frac{{\sum }_{{x}_{i} = 0 °}^{{x}_{i} = 270 °} {lrx}_{i} - {\sum }_{{x}_{i} = 0 °}^{{x}_{i} = 270 °} {ltx}_{i}}{{\sum }_{{x}_{i} = 0 °}^{{x}_{i} = 270 °} {trx}_{i} - {\sum }_{{x}_{i} = 0 °}^{{x}_{i} = 270 °} {ttx}_{i}} ) \qquad Eq . ( 1 )$$

In Eq. (1), ƒ(t) is an empirically derived temperature correction function, which allow measurements and calculations of MOE_{MAX} at different temperatures to be comparable to each other. ρ is the log density that is calculated from log weight data given by weight sensors (see FIGS. 1B and 2B) and log volume data given from a 2-D or 3-D laser scanning system (see FIGS. 1A and 2A), lrxᵢ and ltxᵢ are the longitudinal positions of the receiver and transmitter, respectively, trxᵢ is the registered arrival time at the receiver, and ttxᵢ is the initial/starting time at the transmitter. trxᵢ and taxᵢ are used to determine the elapsed time for an impulse sent by the transmitter to be registered by the corresponding receiver.

Differences between MOE_{MAX} (Eq. 1) and the average modulus of elasticity, MOE_{AVG} Eq. (8), of each log represent radial gradients in impulse velocity and thus in modulus of elasticity, which reflect radial differences in wood structure that will effect the drying and form stability of sawn lumber. The calculated radial gradient MOE_{MAX}−MOE_{AVG} can be used in a log classification algorithm, such as f₁, and compared to empirically derived threshold values (i, j, k, l) that are used to grade the log. In this example, the log diameter (Ø) is also part of algorithm f₁ i.e. the threshold values will be different for logs with varying Ø. Algorithm f₁ can for instance be constructed according to the following principle:

$${f}_{1} = if < x and j < ( Eq . ( 1 ) - Eq . ( 8 ) ) then class = 1$$

$$if < x and i < ( Eq . ( 1 ) - Eq . ( 8 ) ) < j then class = 2$$

$$if < x and i > ( Eq . ( 1 ) - Eq . ( 8 ) ) then class = 3$$

$$if x < < y and 1 < ( Eq . ( 1 ) - Eq . ( 8 ) ) then class = 1$$

$$if x < < y and k < ( Eq . ( 1 ) - Eq . ( 8 ) ) < 1 then class = 2$$

$$if x < < y and k > ( Eq . ( 1 ) - Eq . ( 8 ) ) then class = 3$$

In the above expression for f₁, the radial impulse velocity gradient is expressed through a MOE-gradient. There may also be cases where the radial gradient is expressed more directly through the impulse velocities e.g. such that f₁ depends on Vₘₐₓ−V_{average}, without actually calculating the MOE parameters.

Algorithm f₂

It is possible to detect differences in impulse velocity between longitudinal sectors of a log. Using transit time technology it is possible to derive n number of radial velocities based on n parallel transmitter-receiver pairs (see FIG. 1A-2B). In this case, the impulse velocity is measured in the same way as in Eq. (1) using the shortest distance between each transmitter-receiver pair. However, Eq. (2) uses the individual impulse velocity data calculated for each transmitter-receiver pair attached at a radial log vector (xᵢ) where 0°≦xᵢ≦360° at n positions (e.g. transmitter-sender pair positions at 0°-0°, 90°-90°, 180°-180°, and at 270°-270°) to calculate the impulse velocity (IVELxᵢ) in n radial sectors, i.e. for i=1, . . . , n, according to:

$${IVELx}_{i} = f ( t ) ρ ( \frac{{lrx}_{i} - {ltx}_{i}}{{trx}_{i} - {ttx}_{i}} ) \qquad Eq . ( 2 )$$

In Eq. (2), ƒ(t) is an empirically derived temperature correction function, which allows measurements and calculations of IVELxᵢ at different temperatures to be comparable to each other. ρ is the log density that is calculated from log weight data given by weight sensors and log volume data given from a 2-D or 3-D laser scanning system, lrxᵢ and ltxᵢ are the longitudinal positions of the receiver and transmitter, respectively, trxᵢ is the registered arrival time at the receiver, and ttxᵢ is the initial/starting time at the transmitter. trxᵢ and ttxᵢ are used to determine the elapsed time for an impulse sent by the transmitter to be registered by the corresponding receiver.

Variance and standard deviation of IVELxᵢ (i=1, . . . , n) e.g. calculated according to Eq. (3), Eq. (4), can be used as measures of absolute and relative differences in wood structure among the n longitudinal sectors of the log. The variance and standard deviation of IVELxᵢ (Eq. 3, Eq. 4) are indications of wood structure variation caused by wood defects such as wood rot, knots, compression wood, and spiral grain.

$$\begin{matrix}{IVEL}_{VAR} = {\sum }_{{x}_{i} = 0 °}^{{x}_{i} = 270 °} {( {IVELx}_{i} - Eq . ( 1 ) )}^{2} & Eq . ( 3 ) \\ {IVEL}_{STDDEV} = \sqrt{{IVEL}_{VAR}} & Eq . ( 4 )\end{matrix}$$

Eq. (3) and (4) are used in a classification algorithm f₂ that uses threshold values (a, b, c, d, e, f, g, h, i, j, k, l) to grade logs in property classes that relates to drying deformation and form stability of wood. In this example, the log diameter (Ø) is also part of algorithm f₂ i.e. the threshold values will be different for logs with varying Ø. Algorithm f₂ can e.g. be constructed according to the following principle:

$${f}_{2} = if < x and Eq . ( 2 ) < a or Eq . ( 3 ) > d or Eq . ( 4 ) > f then class = 1$$

$$if < x and a < Eq . ( 2 ) < b and c < Eq . ( 3 ) < d and e < Eq . ( 4 ) < f then class = 2$$

$$if < x and Eq . ( 2 ) > b and Eq . ( 3 ) < c and Eq . ( 4 ) < e then class = 3$$

$$if x < < y and Eq . ( 2 ) < h or Eq . ( 3 ) > k or Eq . ( 4 ) > 1 then class = 1$$

$$if x < < y and h < Eq . ( 2 ) < i and j < Eq . ( 3 ) < k and k < Eq . ( 4 ) < 1 then class = 2$$

$$if x < < y and Eq . ( 2 ) > i and Eq . ( 3 ) < j and Eq . ( 4 ) < k then class = 3$$

Algorithm f₃

Impulse velocity measurements can also be used to detect wood defects by means of impulses sent in a time sequence, i.e. with time delays. This example refers to a system which, in order to illustrate the general principal of using transit time technology to detect wood defects and quantify their severity in a log, is limited to four transmitter-receiver pairs. Alternative numbers of transmitter-receiver pairs, and thus acoustic impulses, are of course possible.

In a system with four transmitter-receiver pairs an impulse can be sent from each transmitter at 0°, 90°, 180°, and 270° with a small time delay with respect to the previous impulse. This makes it possible to detect and register the arrival time at each individual receiver for 16 unique impulse paths between transmitters and receivers, see Table 1.

The time necessary for an impulse to travel through the log and reach one of the receivers is dependent on the material properties in the path between transmitter and receiver. The transit time and velocity will therefore represent wood defects and wood features in the log e.g. wood rot, knots, compression wood, and spiral grain. An impulse velocity above the average impulse velocity generally means that there is one or several defects in the transmitter-receiver impulse path. A system providing n separate transmitter-receiver velocities allows analysis to detect the position of a defect and quantify its severity, as exemplified in log classification algorithm f₃.

TABLE 1
The 16 transmitter-receiver paths in a system using arrival time
at four receivers for each sequential transmitter impulse.

| | Transmitter at 0° | Transmitter at 90° | Transmitter at 180° | Transmitter at 270° |
|---|---|---|---|---|
| | (T_{0°}) | (T_{90°}) | (T_{180°}) | (T_{270°}) |
| Receiver at 0° | T_{0°}-R_{0°} | T_{90°}-R_{0°} | T_{180°}-R_{0°} | T_{270°}-R_{0°} |
| (R_{0°}) | | | | |
| Receiver at 90° | T_{0°}-R_{90°} | T_{90°}-R_{90°} | T_{180°}-R_{90°} | T_{270°}-R_{90°} |
| (R_{90°}) | | | | |
| Receiver at 180° | T_{0°}-R_{180°} | T_{90°}-R_{180°} | T_{180°}-R_{180°} | T_{270°}-R_{180°} |
| (R_{180°}) | | | | |
| Receiver at 270° | T_{0°}-R_{270°} | T_{90°}-R_{270°} | T_{180°}-R_{270°} | T_{270°}-R_{270°} |
| (R_{270°}) | | | | |

That is, using the arrival time of the impulses at receiver positions c. 0°, 90°, 180°, 270° for each individual transmitter, 16 impulse velocities (IVELtᵢrᵢ), one for each transmitter-receiver path, can be calculated according to the principle of Eq. (2). In this case, however, the calculations are not limited to the shortest path and arrival time data between transmitter and receiver pairs, Eq. (5) calculates all impulse velocities for the 16 transmitter-receiver paths in Table 1 (i.e. i=1, 2, . . . , 16).

$${IVEL}_{{t}_{i} {r}_{i}} = f ( t ) ρ ( \frac{{lrx}_{i} - {ltx}_{i}}{{trx}_{i} - {ttx}_{i}} ) \qquad Eq . ( 5 )$$

The variance in impulse velocity can be calculated for all 16 impulses paths according to Eq. (6).

$${IVEL}_{{t}_{i} {r}_{i} VAR} = {\sum }_{{x}_{i} = 0 °}^{{x}_{i} = 270 °} {( {IVEL}_{{t}_{i} {r}_{i}} - ( \frac{\sum {\sum }_{{x}_{i} = 0 °}^{{x}_{i} = 270 °} {IVEL}_{{t}_{i} {r}_{i}}}{16} ) )}^{2} \qquad Eq . ( 6 )$$

The standard deviation for the 16 impulse velocities is calculated according to Eq. (7).

IVELtᵢr_{iSTDDEV}=\sqrt{IVELtᵢrᵢVAR} Eq. (7)

Eq. (5), (6), and (7) can be used to describe the presence and severity of defects in a log using algorithm f₃ where logs are graded into log property classes by means of threshold values (a, b, c, d, e, f). The classification accounts for the wood defects, drying deformation and form stability of the lumber that would be produced from sawlogs from each log property class. In this example, the log diameter (Ø) is also part of algorithm f₃ i.e. the threshold values will be different for logs with varying Ø. Algorithm f₃ can e.g. be constructed according to the following principle:

$${f}_{3} = if < x and Eq . ( 5 ) < a and / or ( Eq . ( 6 ) / Eq . ( 7 ) ) > c then class = 1$$

$$if < x and a < Eq . ( 5 ) < b and ( Eq . ( 6 ) / Eq . ( 7 ) ) < c then class = 2$$

$$if < x and Eq . ( 5 ) \geq b and ( Eq . ( 6 ) / Eq . ( 7 ) ) < c then class = 3$$

$$if x < < y and Eq . ( 5 ) < d and / or ( Eq . ( 6 ) / Eq . ( 7 ) ) > f then class = 1$$

$$if x < < y and d < Eq . ( 5 ) < e and ( Eq . ( 6 ) / Eq . ( 7 ) ) < f then class = 2$$

$$if x < < y and Eq . ( 5 ) \geq e and ( Eq . ( 6 ) / Eq . ( 7 ) ) < f then class = 3$$

Algorithm f₄

It is possible to measure the average modulus of elasticity of logs using acoustic resonance technology as described above with reference to FIGS. 1A-2B and 4. According to a particular embodiment of the invention, there is provided a system in which a higher measurement precision of MOE_{AVG} (Eq. 8), as compared to in prior-art systems, is achieved through measuring the log density, ρ, and log length, l, by using geometrical volume data from a 2-D or 3-D laser scanner paired with data from weight sensors. Moreover, an empirically derived correction function for temperature ƒ(t) is added to Eq. 8 to allow compensation for the effect that temperature variations have on the measured resonance frequency:

MOE_{AVG =“(}t)ρ(2lƒ)² Eq. (8)

Eq. (8) is used in a classification algorithm f₄ that includes threshold values (x, y) to grade logs in property classes based on the modulus of elasticity, e.g. expressed in Giga Pascal (GPa). Algorithm f₄ can e.g. be constructed according to the following principle:
f₄=if MOE_{AVG}<x then class=1
if x<MOE_{AVG}<y then class=2
if y<MOE_{AVG} then class=3

1-21. (canceled)

22. A method for classifying logs comprising the steps of:
applying pressure impulses to a log so as to produce acoustic waves in the log;
determining a first impulse velocity of the log based on transit time measurements on at least one of the acoustic waves;
determining a second impulse velocity of the log based on resonance measurements on at least one of the acoustic waves;
evaluating the quality of the log using a difference between the first and second impulse velocities; and
classifying the log based on the quality evaluation, whereby the log can be automatically sorted accordingly.

23. The method of claim 22, wherein the evaluating step involves calculating a representation of the drying properties of the log formed by the difference between the first and second acoustic velocities.

24. The method of claim 22, wherein the evaluating step involves calculating a radial impulse velocity gradient from the difference between the first and second impulse velocities, whereby the first impulse velocity represents a maximum impulse velocity and the second impulse velocity represents an average impulse velocity.

25. The method of claim 25, comprising the further steps of:
applying a number n of radially separated pressure impulses at one end of the log;
measuring the first impulse velocity by transit time measurements at n corresponding measurement points at the other end of the log; and
evaluating the quality of the log further based on the relationship between the n values of the first impulse velocity provided by the n transit time measurements.

26. The method of claim 25, wherein the n pressure impulses are time-delayed with respect to each other and by evaluating the quality of the log based also on the relationship between the n×n values of the first impulse velocity provided by n×n transit time measurements for different transmitter-receiver paths.

27. The method of claim 22, comprising the further step of automatically determining a geometry parameter of the log and using the geometry parameter in the evaluating step to increase the accuracy of the log classification.

28. The method of claim 27, comprising the further step of automatically determining the weight of the log and using a combination of the weight and the geometry parameter in the evaluating step to increase the accuracy of the log classification.

29. The method of claim 22, comprising the further step of automatically measuring a temperature of the log and using the temperature parameter in the evaluating step so as to correct for a temperature-dependency of a log parameter.

30. The method of claim 22, comprising the further step of sorting the log into predetermined quality classes according to the classifying step before it is processed.

31. A system for classifying logs comprising:
means for applying pressure impulses to a log so as to produce acoustic waves in the log;
means for determining a first impulse velocity of the log based on transit time measurements on at least one of the acoustic waves;
means for determining a second impulse velocity of the log based on resonance measurements on at least one of the acoustic waves;
means for evaluating the quality of the log using a difference between the first and second impulse velocities; and
means for classifying the log based on the quality evaluation, whereby the log can be automatically sorted accordingly.

32. The system of claim 31, wherein the means for evaluating comprises means for calculating a representation of the drying properties of the log formed by the difference between the first and second acoustic velocities.

33. The system of claim 31, wherein the means for evaluating comprises means for calculating a radial impulse velocity gradient from the difference between the first and second impulse velocities, whereby the first impulse velocity represents a maximum impulse velocity and the second impulse velocity represents an average impulse velocity.

34. The system of claim 31, further comprising:
means for applying a number of radially separated pressure impulses at one end of the log; and
means for measuring the first impulse velocity by transit time measurements at corresponding measurement points at the other end of the log;
whereby the means for evaluating the quality of the log is arranged to further base the quality of the log on the relationship between the n values of the first impulse velocity provided by the n transit time measurements.

35. The system of claim 34, wherein means for applying a number of radially separated pressure impulses is arranged to apply the pressure impulses time-delayed with respect to each other and in that the means for evaluating the quality of the log is arranged to base the quality of the log also on the relationship between the n×n values of the first impulse velocity provided by n×n transit time measurements for different transmitter-receiver paths.

36. The system of claim 31, further comprising means for determining a geometry parameter of the log and in that the means for evaluating is adapted for using the geometry parameter to increase the accuracy of the log classification.

37. The system of claim 36, further comprising means for determining the weight of the log and in that the means for evaluating is adapted for using a combination of the weight and the geometry parameter to increase the accuracy of the log classification.

38. The system of claim 31, further comprising means for measuring a temperature of the log and in that the means for evaluating is adapted for using the temperature parameter to correct for a temperature-dependency of a log parameter.

39. The system of claim 31, further comprising sensors arranged so as to move with the log for a predetermined distance during the transit time and resonance measurements.

40. The system of claim 31, further comprising means for sorting the log according to quality classes determined by the means for classifying.

41. A mobile sorting unit for sorting logs before they are industrially processed comprising a classifying system, said classifying system comprising:
means for applying pressure impulses to a log so as to produce acoustic waves in the log;
means for determining a first impulse velocity of the log based on transit time measurements on at least one of the acoustic waves;
means for determining a second impulse velocity of the log based on resonance measurements on at least one of the acoustic waves;
means for evaluating the quality of the log using a difference between the first and second impulse velocities; and
means for classifying the log based on the quality evaluation, whereby the log can be automatically sorted accordingly.

42. A classification unit for classifying logs comprising:
means for receiving a first impulse velocity parameter for a log, said parameter being based on transit time measurements on at least one acoustic wave applied to the log;
means for receiving a second impulse velocity parameter for the log, said parameter being based on resonance measurements on at least one acoustic wave applied to the log;
means for evaluating the quality of the log using a difference between the first and second impulse velocity parameters; and
means for classifying the log based on the quality evaluation, whereby the log can be automatically sorted accordingly.
